(19) United States
(12) Patent Application Publication
(10) Pub. No.: US 2025/0054376 A1
(43) Pub. Date: Feb. 13, 2025

(54) REACTION-AWARE ADAPTIVE INTERVENTION IN A MONITORED AREA

(71) Applicant: International Business Machines Corporation, Armonk, NY (US)

(72) Inventors: Alessandro Pomponio, Dublin (IE); Jonathan Peter Epperlein, Phibsborough (IE); Michele Gazzetti, Dublin (IE)

(73) Assignee: International Business Machines Corporation, Armonk, NY (US)

(21) Appl. No.: 18/230,904

(22) Filed: Aug. 7, 2023

(51) Int. Cl. G08B 7/06; G06V 20/52; G06V 40/20

(52) U.S. Cl. CPC G08B 7/06; G06V 20/52; G06V 40/20

(57) ABSTRACT

The illustrative embodiments provide for supervision and reaction-aware adaptive intervention in an area. An embodiment includes detecting a behavior of a non-compliant entity over a threshold in a supervised area using one or more sensors. The threshold is determined by processing an input of the sensor using a first processing algorithm. The embodiment includes deploying a response into the supervised area. The response is based on input from the sensor. The embodiment includes identifying, using a second processing algorithm, a reaction of the non-compliant entity to the initial response. The embodiment includes determining fulfilment of a target state of the non-compliant entity using a third algorithm. The target state may include a change in behavior of the non-compliant entity. Other embodiments of this aspect include corresponding computer systems, apparatus, and computer programs recorded on one or more computer storage devices, each configured to perform the actions of the embodiment.

### BACKGROUND

The present invention relates generally to monitoring systems. More particularly, the present invention relates to a method, system, and computer program for reaction-aware adaptive intervention in a monitored area.

Smart monitoring systems are ubiquitous in homes, public buildings, and businesses. “Smart” as referred to herein means that the monitoring device has some computing ability. Many monitoring systems include smart cameras, smart motion sensors, smart auditory sensors, smart temperature sensors, etc. Some smart monitoring systems have automated interactions built into the device such as deterrents including sirens, flashing lights, voice recordings, etc. Some smart monitoring systems also include automated interactions which give information such as voice and sound recordings, commands, variable signage, etc. Some monitoring systems are able to adjust interactions based on type of offender or escalate interactions if an alert is not cleared.

### SUMMARY

The illustrative embodiments provide for supervision and reaction-aware adaptive intervention in an area. An embodiment includes detecting a behavior of a non-compliant entity over a threshold in a supervised area using a sensor. The threshold may be determined by processing an input of the sensor using a first processing algorithm. The input may be a visual input in some embodiments. The visual input may come from a camera. In other embodiments the input may be an audio input. The embodiment also includes deploying a response from a database or as a result of dynamically processing the input into the supervised area. The response may be based on input from the sensor. The embodiment also includes identifying, using a second processing algorithm, a reaction of the non-compliant entity to the initial response. The embodiment also includes determining fulfilment of a target state of the non-compliant entity using a third algorithm. The target state may include a change in behavior of the non-compliant entity. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example monitoring system and monitored area in accordance with an illustrative embodiment;

FIG. 3 depicts a flowchart of an example process for monitoring an area and adapting to reactions from an entity in accordance with an illustrative embodiment;

FIG. 4 depicts a flowchart of an example process for monitoring an area and adapting to physical reactions from an entity in accordance with an illustrative embodiment; and

FIG. 5 depicts a flowchart of an example process for monitoring an area and adapting to sentiment reactions from an entity in accordance with an illustrative embodiment.

### DETAILED DESCRIPTION

Smart monitoring systems are ubiquitous in homes, public buildings, and businesses. “Smart” as referred to herein means that the monitoring device has some computing ability. Many monitoring systems include smart cameras, smart motion sensors, smart auditory sensors, smart temperature sensors, etc. Some smart monitoring systems have automated interactions built into the device such as deterrents including sirens, flashing lights, voice recordings, etc. Some smart monitoring systems also include automated interactions which give information such as voice and sound recordings, commands, variable signage, etc. Some monitoring systems are able to adjust interactions based on type of offender or escalate interactions if an alert is not cleared.

Computer vision and processing algorithms have learned to gauge reactions from a video input. For example, a camera coupled with a processing algorithm may be able to gauge changes to a person's face. The processing algorithm may be able to gauge the sentiments of fear and anger. Sentiments as referred to herein means attitude toward a situation or event. Computer vision and processing algorithms may be able to gauge a change in posture. Detection of emotions may be based on body parts and not on facial expressions. Computer vision and processing algorithms may also be able to gauge reactions based on the voice of a speaker.

Currently some monitoring systems can adjust interactions of such devices including but not limited to sirens, lights, audio recordings, commands, and signage based on the type of non-compliant entity. Some monitoring systems can also escalate interactions of devices if the alert is not cleared. However, there are no monitoring systems that can both gauge reactions of a non-compliant entity and adapt the interaction device to achieve a target state in a non-compliant entity. Therefore, there exists a need to combine smart monitoring systems with processing algorithms in order to engage the cause of non-compliance in the non-compliant entity, monitor the reaction of the non-compliant entity, and adjust the deterrent, interactions, or modality with the non-compliant entity if necessary to attain the desired target state using reinforcement learning. As referred to herein, deterrent includes, but is not limited to sirens, flashing lights, voice records, etc.

For example, a monitoring system may observe a non-compliant entity in a restricted area and may interact with the entity using voice commands such as, by non-limiting example, “The exit is behind you” or “No, stop gathering more. Leave what you already took and go.” If the entity does not comply with the commands the monitoring system may then adapt the deterrent interaction to a sound recording of dogs barking to cause fear in the non-compliant entity. If that does not work, the monitoring system may change the deterrent interaction to a siren or threatening language. In illustrative embodiments, the monitoring system may also change the language of the command if the non-compliant entity is determined by the system to not have responded or does not reach the target state.

The monitoring system may also interact with the non-compliant entity by adapting the modality of the deterrent or interaction. As referred to herein, modality includes audible interactions or deterrents, visual interactions or deterrents, and the like. Adapting the modality may include, by non-limiting example, changing auditory information to visual signage to interact with the non-compliant entity. If the deterrent used is a siren, the volume of the siren may be increased to illicit a target state in the non-compliant entity. If the deterrent is flashing lights, the brightness of the light may be increased to illicit a target state in the non-compliant entity. The system may continue to cycle through deterrents and interactions or different modalities until a target state is reached in a non-compliant entity. The system may use a reinforcement learning algorithm that evaluates how the response affects a non-compliant entity. In various embodiments, the reinforcement learning algorithm may improve the way that responses are deployed from the database. In some embodiments, other learning methods may be used to evaluate how the response affects the non-compliant entity.

The illustrative embodiments provide for supervision and reaction-aware adaptive intervention in an area. A “smart” monitoring system as referred herein is a monitoring system including a device with some computing capability such as by non-limiting example, smart cameras, motion sensors, auditory sensors, temperature sensors, etc. Embodiments disclosed herein describe the smart monitoring systems for surveillance and security; however, use of this example is not intended to be limiting but is instead used for descriptive purposes only. Instead, smart monitoring systems can include systems used to interact with a non-compliant entity such as, by non-limiting example, patrons in a library who are speaking too loudly, or a domesticated animal left at home that is displaying non-obedient behavior such as biting household items or jumping on furniture.

A “deterrent” as referred to herein is an interaction with an entity that will cause them to stop what they are doing and leave an area such as by non-limiting example, sirens, flashing lights, voice recordings.

A “modality” as referred to herein is a type of sensory experience. For example, a change in modality of a deterrent may go from an auditory modality to a visual modality.

An “interaction” as referred to herein is an output given by a device of a smart monitoring system which interacts with a non-compliant entity. For example, an interaction may be a deterrent such as a siren or information given to the non-compliant entity such as voice recordings, and variable signage.

A “sentiment” as referred to herein is an attitude toward an interaction of the smart monitoring system. For example, a non-compliant entity may have an aggressive attitude when breaking into a house. The target state of the system for the non-compliant entity may be a fearful sentiment that then causes the non-compliant entity to flee the area of monitoring.

A “target state” as referred to herein is a behavior or activity that the monitoring system is trying to achieve in the non-compliant entity. For example, a target state for a non-compliant entity in a restricted area would be for the non-compliant entity to leave. In some illustrative embodiments, the target state may be for the library patrons to use a lower voice. In other illustrative embodiments, the target state would be for an intruder to leave a house.

A “sensor” as referred to herein is a device that is able to observe and record information in an area. For example, a video camera is a sensor that can observe both visual and auditory information in a monitored area. In another example, a speaker is a sensor that could observe and record auditory information in a monitored area. A sensor may also include a thermometer to observe and record the temperature in a monitored area. A sensor may also be a motion sensor that can observe and detect movement in an area.

As described herein “dynamically” means that the response is chosen based on constant input from the sensors. For example, an initial response may be deployed based on input from the sensors of the system. A new response may be chosen based on a reaction to the response from the non-compliant entity.

Illustrative embodiments include detecting, using a sensor, a behavior of a non-compliant entity over a threshold in a monitored area. A sensor includes a video camera, a speaker, a microphone, a motion sensor, and combinations thereof. A threshold is determined by processing an input of the sensor using a processing algorithm. A non-compliant entity may include a human. A non-compliant entity may also include an animal.

Illustrative embodiments include deploying a response into the monitored area. The responses are deployed using an intervention actuator. The responses are selected from a database. The database is loaded with responses to non-compliant entities based on the locations and behavior observed by the sensors. The responses are based on sensor input. The response may include a deterrent such as siren or voice recording. The voice recording may include a command to leave the area. In illustrative embodiments, the responses may also include sound recordings such as animal sounds. The animal sounds may be used to illicit a scared sentiment in the non-compliant entity.

Illustrative embodiments identify a reaction of the non-compliant entity to an initial response, using an adaptation algorithm. In illustrative embodiments, a reaction may include a sentiment reaction such as a non-compliant entity such as, by non-limiting example, a change from a neutral sentiment to a scared sentiment. In other embodiments, a reaction may include a reaction that is a change in behavior such as a library patron changing from using a loud speaking voice to a quiet speaking voice. A change in behavior may also include an entity using a telephone such as a cellular phone. In some embodiments, the system may timeout if the reactions have not caused a change in a non-compliant entity. A timeout may cause an alert to be sent to a user interface. An alert sent to a user interface may escalate the situation to require human interaction.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures, therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

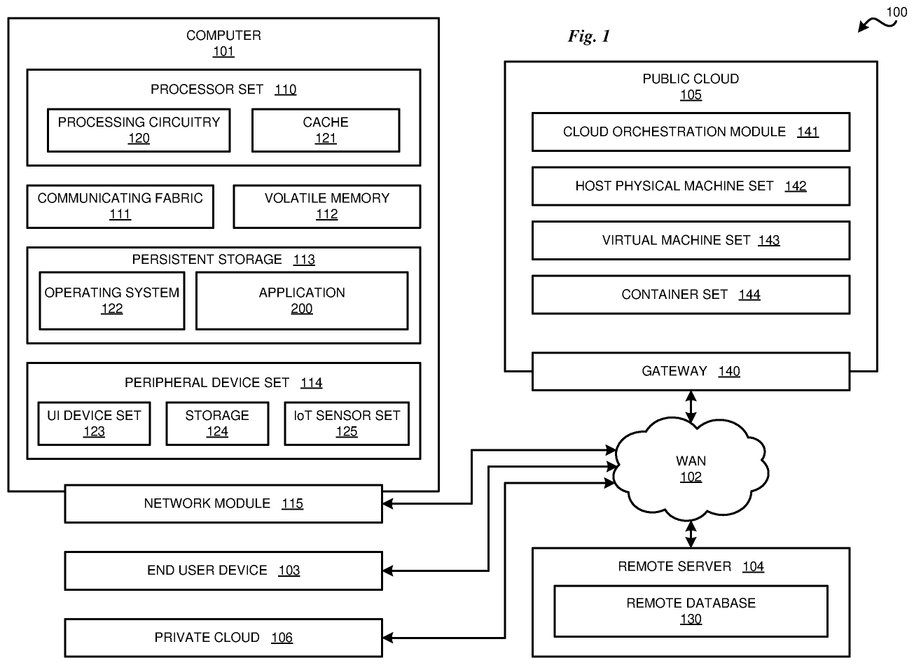

With reference to FIG. 1, this figure depicts a block diagram of a computing environment 100. Computing environment 100 contains an example of an environment for the execution of at least some of the computer code involved in performing the inventive methods, such as reaction-aware intervention in a monitored area. In addition to application 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and application 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in application 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in application 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

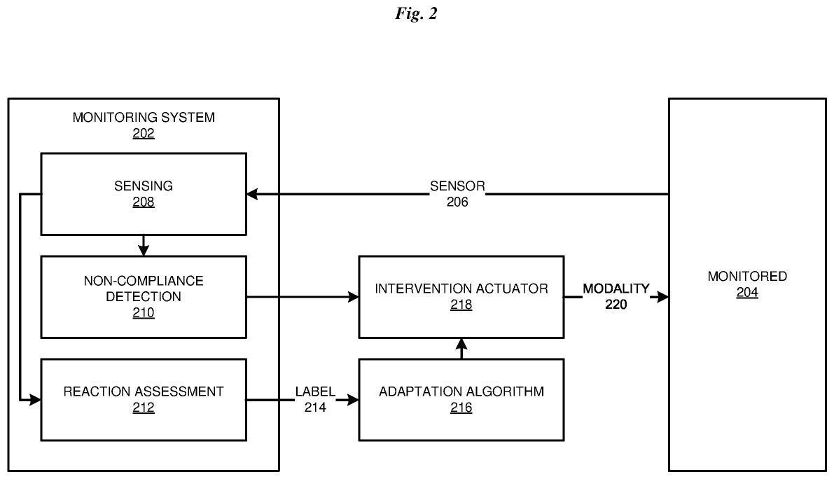

With reference to FIG. 2, this figure depicts a block diagram of a reaction aware smart monitoring system 202 in accordance with an illustrative embodiment. In the illustrated embodiment, the smart monitoring system 201 includes the application 200 of FIG. 1.

In the illustrated embodiment, the reaction aware monitoring system includes at least one sensor, capability to assess and label the reaction of a non-compliant entity with at least one target label, a set of interaction and intervention capabilities with a corresponding actuator, and at least one algorithm to adjust interactions and responses towards the non-compliant entity to achieve the target state. The at least one sensor may include a visual sensor such as a camera or an audio sensor such as a microphone. Through the use of the sensor, the system 202 senses an entity in the supervised area. The sensor must be rich enough to gauge a reaction of a non-compliant entity. In various implementations, the entity may be a non-compliant entity.

The labels assigned to the reactions of the non-compliant entity include, but are not limited to, understanding, fear, anger, and the like. The capability to assess will also include determining continuous or discrete displays of the reactions and degrees of the reactions by the non-compliant entity. The set of interactions, interventions, and responses that correspond with the intervention actuator 218 may include dialogue, deterrent sounds for example from a speaker, signage for example on a light emitting diode (LED) sign. The at least one algorithm to adjust an interaction towards achieving a target state may be able to, for example, change a language of the sign or voice recording until the sentiment of understanding is detected. In some embodiments, more complex reinforcement learning strategies may be used.

In the illustrated embodiment, the reaction aware smart monitoring system 202 monitors a supervised area 204. The monitoring system 202 monitors the area using at least one sensor. In various embodiments, the sensors may include a visual sensor such as a camera or an audio sensor such as a microphone. Through the use of the sensor, the system 202 senses an entity in the supervised area. The sensor must be rich enough to gauge a reaction of a non-compliant entity. In various implementations, the entity may be a non-compliant entity.

As used herein “non-compliant” entity means a person or animal that is not authorized to be in the area. In some implementations, the entity may only become non-compliant when it exhibits an undesired behavior. An undesired behavior may include a behavior from an animal. The animal may be domesticated or wild. The domesticated animal may exhibit a non-compliant behavior such as getting on furniture, biting household items, getting into the trash, or barking at restricted times. Non-compliant behavior by a wild animal may include digging, biting, or other similar behaviors that a human does not want the animal to do.

Regarding a human, an example of non-compliant behavior when the person is otherwise authorized to be in an area may include smoking in a place where smoking is prohibited, vandalizing a public place, spending too much time in one location, or making too much noise in a public place such as a library.

In the illustrated embodiment, the monitoring system 202 may sense the non-compliant entity behaving over a threshold in the monitored area. The threshold may be determined by processing an input of the sensor 206 using a processing algorithm. The system detects non-compliance through a non-compliance detection module 210 and deploys a response to the non-compliant entity. The response is deployed through the intervention actuator 218. The response to the non-compliant entity may be a predetermined response selected from a database. In some embodiments, the database may be a hardwired database. In other embodiments, the database may be a cloud-based database in a different location from the monitoring system. The response is deployed into the monitored area using a predetermined modality for the type of response deployed from the database. In various embodiments, the modality of the response may be a visual modality such as a light. In other embodiments, the modality may be an auditory modality such as a sound. The sound may be at a large decibel in some embodiments. In other embodiments, the sound may be at a standard decibel but may be a sound considered irritating to the average person. In still other embodiments, the sound may be selected to illicit a sentiment of fear in the non-compliant entity.

Through the sensor 206 the monitoring system 202 may sense a reaction of the non-compliant entity through the sensing module 208. The sensing module may then send the information of the reaction to the reaction assessment module 212. The reaction assessment module will label 214 a reaction of the non-compliant entity and send the information to the adaptation algorithm 216 to identify the reaction and determine if a second response should be deployed to the non-compliant entity. A second response will be deployed to the monitored area in an attempt to reach a target state of a non-compliant entity. The target state may include a change in sentiment such as, by non-limiting example, from neutral to scared, angry to fearful, or the like. The target state may include, but is not limited to, the non-compliant entity leaving the monitored area or ceasing the undesired behavior.

The monitoring system will continue to sense, assess, and deploy responses until the target state has been fulfilled. In various implementations, the monitoring system may change the modality of the response. For example, the first response may be a flashing light and the second response may be a loud sound. In other embodiments, a response may include a sign that lights up revealing a message to a non-compliant entity. In other implementations, the sign may be a digital sign where the message or the language of the message can be changed based on a reaction assessment by the system. The system may use a reinforcement learning algorithm that evaluates how the response affects a non-compliant entity. In various embodiments, the reinforcement learning algorithm may improve the way that responses are deployed from the database.

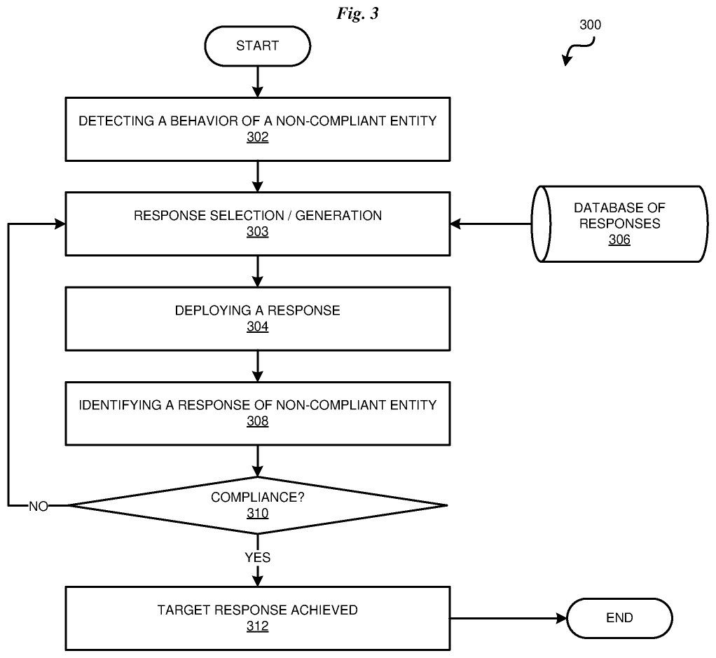

With reference to FIG. 3, this figure depicts a flow chart of a method of an exemplary reaction aware monitoring system 300 in accordance with an illustrative embodiment. In the illustrated embodiment, the system 300 is an example of the system 202 of FIG. 2.

In the illustrated embodiment, the method includes detecting a behavior of a non-compliant entity 302. The non-compliant entity may be detected through the use of sensors coupled with the monitoring system. The sensors may include, by non-limiting example, video cameras, microphones, or motion detectors. The method also includes deploying a response into a monitored area. The response may be chosen based on input from the sensors 303. In some embodiments, the response may be chosen from a database of responses 306. In other embodiments, the response may be dynamically generated based input from the sensors. The response is deployed using an intervention actuator. The response is selected from a database. The database may be a hardwire database or a cloud-based database. The response deployed is based on input from the sensor.

In the illustrated embodiment, the method includes identifying a reaction of the non-compliant entity. The reaction is identified using one or more sensors capable of gauging a sentiment of the non-compliant entity. The sensors include a video camera or a microphone. The reaction is identified using a processing algorithm. As illustrated, the system then determines if the non-compliant entity has complied 310 with the request or command. If the non-compliant entity has not complied, then the system deploys a second response, using an adaptation algorithm, from the database. The second response is based on the reaction of the non-compliant entity. The method also includes determining, using a processing algorithm, whether fulfilment of the target state has been achieved. If the target state has been achieved, then the method stops interacting and returns to a monitoring state.

In various implementations, the method further includes repeating deploying of responses and identifying the reaction of the non-compliant entity. The system will continue deploying responses until a target state has been achieved in some embodiments. In other embodiments, the system may deploy a set number of responses. After the set number of responses has been met, the system may notify appropriate personnel to continue interacting with the non-compliant entity. In some embodiments, the system may timeout if the reactions have not caused a change in a non-compliant entity. A timeout may cause an alert to be sent to a user interface. An alert sent to a user interface may escalate the situation to require human interaction.

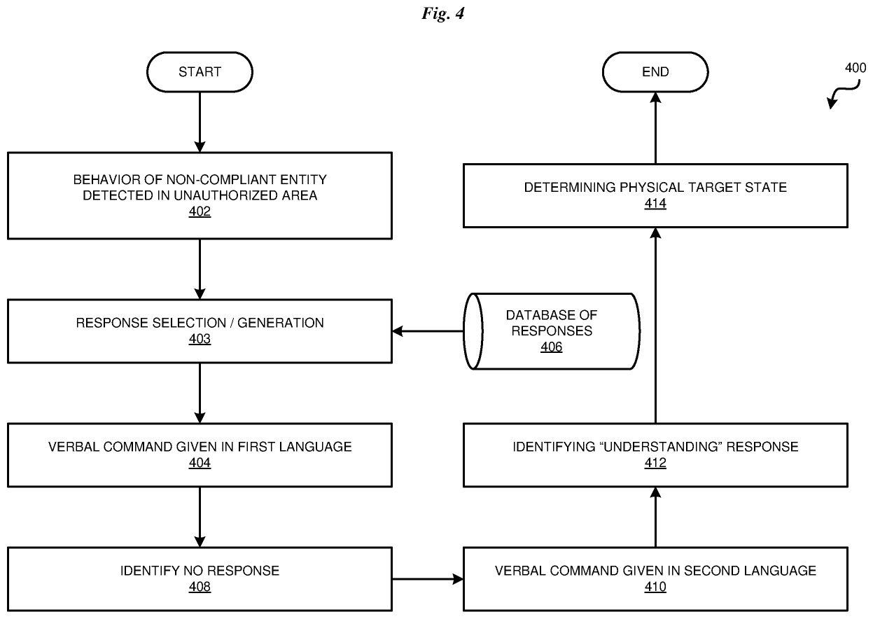

With reference to FIG. 4, this figure depicts a flow chart of an exemplary reaction aware interaction monitoring system of an application 200 in accordance with an illustrative embodiment. In the illustrated embodiment, the method 400 uses the monitoring system of an example of the network 202 of FIG. 2.

In the illustrated embodiment, the method includes detecting behavior of a non-compliant entity in an unauthorize location. The system detects the behavior using a video camera 402. The video camera is capable of gauging a reaction of the non-compliant entity after the system deploys a response 404. In this particular embodiment, the system deploys a verbal command to the non-compliant entity. The command is given in a first language. The verbal command is one or many responses preloaded into a database of response. In some embodiments, an initial response may be generated based on input from the sensors. The system then, using the video camera and the processing algorithm, identifies that the non-compliant entity did not respond to the command. Using the adaptation algorithm, the system deploys the command in a second language. The system again senses the reaction of the non-compliant entity using the video camera and processing algorithm. The system identities a sentiment response of “understanding” in the non-compliant entity. After understanding the command, the non-compliant entity leaves the restricted area, and the system determines the physical target state has been achieved. Once the physical target state is achieved, the system returns to a monitoring state. In various implementations, the system determines a sentiment target state, a physical target state, a behavior target state, or a combination thereof.

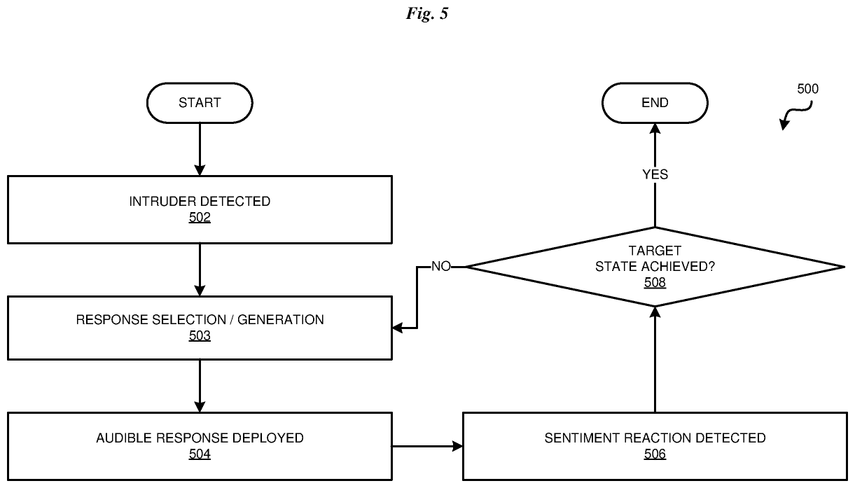

With reference to FIG. 5, this figure depicts a flow chart of an exemplary reaction aware interaction monitoring system of an application 200 in accordance with an illustrative embodiment. In the illustrated embodiment, the method 400 uses the monitoring system of an example of the network 202 of FIG. 2.

In the illustrated embodiment, the system detects an intruder 502. In various embodiments, the intruder may be detected by one of a visual sensor, an auditory sensor, a motion sensor, or a combination thereof. Once an intruder is detected another sensor may be activated. The other sensor may include a visual sensor or an auditory sensor that is capable of gauging a reaction of the intruder. The system may determine to deploy a response based on input from the sensors 403. In some embodiments, the response may be chosen from a database 406. In other embodiments, the response may be dynamically generated based on input from the sensors. As described herein “dynamically” means that the response is chosen based on constant input from the sensors. A new response may be chosen based on a reaction from the non-compliant entity.

In the illustrated embodiment, the system deploys an audible response 504. The audible response may include a recording of dogs barking. A reaction of the non-compliant entity is identified using an adaptation algorithm. In this particular example, a sentiment reaction is detected 508. The sentiment reaction is happiness. Happiness is not a desired sentiment when trying to deter an intruder from remaining in a location. Therefore, the target state 508 is not achieved and the system deploys a second audible response. The second audible response 504 may be a recording of sirens or a voice recording giving a command. In various implementations, the voice recording could tell the intruder to put down any items they have picked up and to leave the scene. The system identifies a second reaction of the intruder using the adaptation algorithm. The second reaction is a fear sentiment, and the intruder flees the scene. The system determines, using a processing algorithm, the target state by the non-compliant entity. Once the target state is fulfilled the system returns to a monitoring state.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases do not necessarily refer to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
detecting, using one or more sensors, a behavior of a non-compliant entity over a threshold in a monitored area, wherein the threshold is determined by processing an input of the sensor using a processing algorithm;
deploying, using an intervention actuator, a response, into the monitored area, wherein the response is based on the input of the sensor;
identifying, using an adaptation algorithm, a reaction of the non-compliant entity to the response; and
determining, using the processing algorithm, fulfilment a target state by the non-compliant entity, wherein target state comprise a change in behavior by the non-compliant entity.

2. The computer-implemented method of claim 1, wherein the response is selected from a database.

3. The computer-implemented method of claim 1, wherein the response is generated based on the input of the sensor.

4. The computer-implemented method of claim 1, further comprising: when the reaction of the non-compliant entity is not the target state, deploying, a second response from the database, the second response based on the reaction of the non-compliant entity.

5. The computer-implemented method of claim 1, further comprising, repeating deploying a response and identifying the reaction until the target state is reached.

6. The computer-implemented method of claim 1, further comprising a timeout sequence in response to not reaching the target state after deploying a set number of responses.

7. The computer-implemented method of claim 1, wherein the target state comprises the non-compliant entity following a command deployed as the response.

8. The computer-implemented method of claim 1, wherein the processing algorithm processes a visual input.

9. The computer-implemented method of claim 1, further comprising a learning algorithm that evaluates how the response affects the non-compliant entity.

10. A computer program product comprising one or more computer readable storage media, and program instructions collectively stored on the one or more computer readable storage media, the program instructions executable by a processor to cause the processor to perform operations comprising:
detecting, using a sensor, a behavior of a non-compliant entity over a threshold in a monitored area, wherein the threshold is determined by processing an input of the sensor using a processing algorithm;
deploying a response into the monitored area, wherein the response is based on the input of the sensor;
identifying, using the processing algorithm, a reaction of the non-compliant entity to the response; and
determining, using the processing algorithm, fulfilment a target state by the non-compliant entity, wherein target state comprise a change in behavior by the non-compliant entity.

11. The computer program product of claim 10, wherein the stored program instructions are stored in a computer readable storage device in a data processing system, and wherein the stored program instructions are transferred over a network from a remote data processing system.

12. The computer program product of claim 10, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
when the reaction of the non-compliant entity is not the target state, choosing, a second response from the database, the second response based on the reaction of the non-compliant entity.

13. The computer program product of claim 10, wherein the response is selected from a database.

14. The computer program product claim 10, wherein the response is generated based on the input of the sensor.

15. The computer program product claim 10, further comprising, repeating deploying a response and identifying the reaction until the target state is reached.

16. The computer program product claim 10, further comprising a learning algorithm that evaluates how the response affects the non-compliant entity.

17. A computer system comprising a processor and one or more computer readable storage media, and program instructions collectively stored on the one or more computer readable storage media, the program instructions executable by the processor to cause the processor to perform operations comprising:
detecting, using a sensor, a behavior of a non-compliant entity over a threshold in a monitored area, wherein the threshold is determined by processing an input of the sensor using a processing algorithm;
deploying a response into the monitored area, wherein the response is based on the input of the sensor;
identifying, using the processing algorithm, a reaction of the non-compliant entity to the response; and
determining, using the processing algorithm, fulfilment a target state by the non-compliant entity, wherein target state comprise a change in behavior by the non-compliant entity.

18. The computer system of claim 17, wherein the response is selected from a database.

19. The computer system of claim 17, wherein the is generated based on the input of the sensor.

20. The computer system of claim 17, further comprising when the reaction of the non-compliant entity is not the target state, choosing, a second response from the database, the second response based on the reaction of the non-compliant entity.
